(19) United States
(12) Patent Application Publication
(10) Pub. No.: US 2007/0203855 A1
(43) Pub. Date: Aug. 30, 2007

(54) Index and financial product and method and system for managing said index and financial product

(75) Inventor: Mark Bradley Fisher, Woodmere, NY (US)

Correspondence Address: STROOCK & STROOCK & LAVAN LLP, 180 MAIDEN LANE, NEW YORK, NY, 10038, US

(73) Assignee: MBF INDEX HOLDINGS LLC

(21) Appl. No.: 11/710,220

(22) Filed: Feb. 23, 2007

Related U.S. Application Data
(60) Provisional application No. 60/778,167, filed on Feb. 27, 2006.
(60) Provisional application No. 60/811,241, filed on Jun. 5, 2006.

(51) Int. Cl. G06Q 40/00

(52) U.S. Cl. 705/36 R

(57) ABSTRACT

An index generally includes two index components. A first index component tracks a basket of futures contracts including at least two or more sets of futures contracts with different delivery months spread over a selected time period. The basket of futures contracts being rolled as certain futures contracts in the basket approach expiration. A second index component tracks a roll differential that indexes to a starting value periodically adjusted by a differential substantially equal in value to a delta between a first value of the futures contracts in the basket approaching expiration and a second value of futures contracts being rolled into a delivery period subsequent to the ending delivery period of the selected time period. The index is priced at least in part based on index values of the basket of futures contracts and the roll differential. Various financial instruments may be created to track the price of the index.

### CROSS-REFERENCE TO RELATED APPLICATIONS

This application claims priority to U.S. Provisional Patent Application No. 60/778,167, filed Feb. 27, 2006, and U.S. Provisional Patent Application No. 60/811,241, filed Jun. 5, 2006, the entire disclosures of which are incorporated herein by reference.

### BACKGROUND OF THE INVENTION

1. Field of the Invention

The present invention relates to an index tracking one or more futures contract, various financial products that enables the sale, purchase, and/or trading of products linked to or tracking the index, and a method and system of creating and managing the index and related financial products.

2. Description of the Related Art

The New York Mercantile Exchange (NYMEX), Chicago Mercantile Exchange (CME), the Intercontinental Exchange (ICE), and other similar exchanges enable the trading of cash commodities and futures contracts for the same. Such commodities include, but are not limited to, agricultural, soft, and farm-based commodities (e.g., sugar, coffee, pork bellies, corn, and soy beans to name a few), precious metals (e.g., gold, silver, platinum, etc.), and energy based commodities (e.g., crude oil, natural gas, electricity, coal, etc.). While contracts for physical delivery of the underlying commodity can be purchased (and often are), futures contracts provide an opportunity for a buyer or seller of the commodity to enter into an agreement to buy or sell the commodity at a designated future time at a price agreed upon at the time the agreement is made-typically several months prior to the designated future time. As is well known in the art, futures contracts are standardized according to the quality, quantity, and delivery time and location for each type of commodity.

One advantage of futures contracts is that they can be used to hedge other investments. A hedge is a transaction used to offset the risk of another related transaction. For instance, if one were a buyer of oil and desired to minimize the risk of future price increases in oil, a hedged position could be entered. To effect the hedge, the buyer would buy an oil futures contract at a certain price. When the time came to actually buy the physical oil, the buyer would then sell the futures contract. If the price of oil had increased, then the increased price of buying the physical oil at a higher price would be substantially offset by the gain made from buying and selling the oil futures contract.

In some instances, it is desirable to enter into hedged positions for a certain period of time. For example, a company that knows it will be buying oil for a number of months may wish to create hedged positions for each of the months out a year or more. In other cases, the price of futures contracts can be used purely as an investment vehicle. For example, there are known commodities indexes. Such indices generally calculate an index price, much like the Standard & Poor's (S&P) index, for a weighted basket of commodities from a broad range of sectors. These indices can sometimes be purchased as an investment. However, unlike an investment in the S&P index, which trades equities or stocks, an investment in a futures-based index must be consistently rolled because futures contracts expire. For this reason, most commodities futures-based indices are operated like a bond fund of a specific duration.

In managing such indices, the current futures month upon which the index is based is rolled to the next futures month. This rolling process generally occurs on a monthly basis. Because a sizable number of contracts must be rolled every month as compared to the open interest in the respective commodities every month, the pricing of the respective futures contracts may realize downward pressure in the current month which is being sold and upward pressure in the forward month being rolled into or bought. In a contango market (i.e., a market in which the forward futures prices are progressively higher than the current or spot month), the spread between the current month being sold and the forward month being rolled into is increased. This effect can be characterized as a negative roll. A negative roll means that the spot price of the commodities has to rise by at least the negative roll amount in order for the index to break even. A negative roll, thus, decreases the return of the index as an investment vehicle. Moreover, the negative roll in a contango market, which is exacerbated by the forward weighting of presently known commodity indexes such as those described herein, therefore, disadvantageously affects returns from investing such commodity indexes and decreases its suitability as a hedging vehicle.

Moreover, in the trading of various commodities, currencies, debt instruments and other types of financial instruments, it is often desirable to take advantage of certain market conditions by creating hedged transactions or by speculating as to the price of one or more instruments relative to another. In a simple form, a spread (or straddle, as it is sometimes referred to) involves the simultaneous purchase and sale of separate futures or options contracts for the same commodity for delivery in different months. While such spreads can be used to speculate on the difference in price between the two contract months or to hedge another transaction, the creation of spread transactions may result in numerous transaction costs depending on the number of spreads required to be entered and then exited. Furthermore, the ability to create the appropriate spread may be limited by the open interest or liquidity of the underlying futures contract. In fact, if open interest is low, additional costs may be realized in the creation of the spread.

These highlighted disadvantages are exacerbated when more complex spread transactions are desired, such as when an investor desires to create a spread to track multiple commodity types or to track a particular industry, such as the energy or agricultural industries. Given the number of transactions that would be required to track an entire industry of commodities, for example, using individual spread transactions, the potential returns from such investments would be diminished in some cases to the point where the investments became impractical. Moreover, because it is known that commodity tracking indexes must be rolled, the prices of some or all of the futures contracts for those commodities that comprise the index may be artificially increased. This effect can also disadvantageously increase the cost of the index, thereby making the index a less effective investment vehicle.

Consequently, there is a need in the art for a financial product that can reduce the effects of negative roll, while providing position flexibility in that, among other benefits, any number of forward futures contracts can be part of the product (e.g., an index based on 12-months of rolling futures contracts) and a potential investor can take either a long or short position on the product. There is also a need in the art for a financial product that depending on the manner in which the financial product is structured, may also permit long-term hedging applications and advantageously reduce market volatility, reduce roll slippage, and, in some instances, provide “real-time” mark-to-market pricing.

### SUMMARY OF THE EMBODIMENTS OF THE INVENTION

The present invention in its various embodiments overcomes shortcomings in the prior art. In general, an index in accordance with an embodiment of the present invention includes at least one futures contract for each of a selected plurality of futures contract delivery times within a selected index period. The index period will generally include a first futures contract delivery time and a second futures contract delivery time. In order to maintain the selected index period, the futures contracts for the first futures contract delivery time are rolled into a third futures contract delivery time occurring after the second futures contract delivery time are bought. This “roll” is generally performed by selling futures contracts for the first futures contract delivery time and purchasing an equal number of futures contracts for the third futures contract delivery time occurring after the second futures contract delivery time.

The index may include a second component, referred to herein as a cumulative rolling differential or “CRD,” that tracks one or more differentials so as to reduce or minimize the effect of rolling the index. The CRD may be calculated by determining a delta between a first price for a selected number of futures contracts for at least one futures type that fall within a first period and a second price for a selected number of futures contracts for the at least one futures type that fall within an expiration month subsequent to a last expiration period of the at least two expiration periods. Thus, a benchmark value of the CRD may be adjusted using the calculated rolling differential value. Thereafter, the CRD may be combined with an index value or, in some embodiments, the index value may be adjusted by the differential value. This additional cumulative rolling differential component may be used as a standalone product or in combination with the index being presently described. As described further below, various financial instruments, such as, by way of non-limiting example, structured notes, ETFs, futures contracts, swaps, and other derivative contracts, may be based on, track, incorporate, or relate to the index and the cumulative rolling differential.

In an embodiment, a method of calculating an index price for an index including a selected number of futures contracts for at least one futures type where the a selected number of futures contracts are spread among a selected time period including at least two expiration periods and wherein the selected time period is maintained by rolling the index, comprises: calculating a first index component price for the index for the selected time period by indexing values for the selected number of futures contracts for the at least one futures type included in the index; calculating the index price by adding the first index component price to a second index component price wherein the second index component price is initially set at a first value. In said embodiment, the index price is preferably recalculated at least at each roll period by recalculating the first index price by indexing then current values for the selected number of futures contracts for the at least one futures type included in the index.

In another embodiment, a system for calculating an index price for an index including a selected number of futures contracts for at least one futures type where the a selected number of futures contracts are spread among a selected time period including at least two expiration periods and wherein the selected time period is maintained by rolling the index, comprises: a computer operative with programming to calculate a first index component price for the index for the selected time period by indexing values for the selected number of futures contracts for the at least one futures type included in the index; calculate the index price by adding the first index component price to a second index component price wherein the second index component price is initially set at a first value. In said embodiment, the computer is further programmed to recalculate the index price at least at each roll period by recalculating the first index price by indexing then current values for the selected number of futures contracts for the at least one futures type included in the index; calculating a rolling differential value by determining a delta between a first price for the selected number of futures contracts for the at least one futures type that fall within a first period of the at least two expiration periods and a second price for the selected number of futures contracts for the at least one futures type that fall within a forward expiration month subsequent to a last expiration period of the at least two expiration periods; adjusting the first value of the second index component price using the rolling differential value; and calculating the index price by combining the first index component price and the second index component price.

In yet another embodiment, a financial instrument based on the index may include a first security component that indexes to a basket of futures contracts, the basket including at least two or more sets of futures contracts with different delivery months spread over a selected time period and wherein the basket of futures contracts is rolled as certain futures contracts in the basket approach expiration; a second security component indexes to a starting value periodically adjusted by a differential substantially equal in value to a delta between a first value of the futures contracts in the basket approaching expiration and a second value of futures contract being rolled into a forward delivery month; and pricing the financial instrument at least in part based on values of the first security component and the second security component.

The terms “financial instrument” or “instrument,” as used herein, generally refer to a financial product or investment that can be priced and sold on an exchange or on an “over-the-counter” basis, including but not limited to futures contracts, forward contracts, equities, bonds, exchange traded funds (ETFs), notes, other securities, swaps, other derivatives, indices, currencies, interest rates, other fixed income products, and options on any of the foregoing or combinations thereof.

Additional features and advantages of the present invention are described further below. This Summary section is meant merely to illustrate certain features of the invention, and is not meant to limit the scope of the invention in any way. The failure to discuss a specific feature of the invention, or the inclusion of one or more features in this Summary Section, should not be construed to limit the invention as claimed.

### BRIEF DESCRIPTION OF THE FIGURES

Embodiments of the invention will be described and shown in detail by way of example with reference to the accompanying drawings in which:

FIG. 1 is a depiction of an embodiment of a commodities index based on the present invention;

FIG. 2 depiction of an embodiment of a commodities index based on the present invention after being rolled;

FIG. 3a is an illustration of the operation of a cumulative rolling differential in accordance with an embodiment of the present invention;

FIG. 3b is another illustration of the operation of a cumulative rolling differential in accordance with an embodiment of the present invention;

FIG. 3c is an example of an index period configured to match the portion of a futures contract curve where the price differential between the first and last months is zero;

FIG. 4 is a schematic of a system for managing, enabling the sale, purchase, and/or trading of the commodities index of the present invention;

FIG. 5 is a flow chart showing an embodiment for enabling user customizable indexes; and

FIG. 6 is a compilation of data depicting an example of a 6-month multi-period index and cumulative rolling differential in accordance with an embodiment of the present invention.

### DETAILED DESCRIPTION OF THE PREFERRED EMBODIMENTS

In accordance with a preferred embodiment of the invention, a financial instrument includes a multi-period index for one or more types of financial products, such as a basket of commodity futures, for a specified number of forward months. The number of forward months may be selected based upon the objectives and needs of the investor. For example, futures contracts for crude oil can be purchased for a 12-month forward period. In this example, futures contracts may be purchased for January 2007 through and including December 2007. Alternate embodiments to be described in greater detail herein may utilize longer or shorter periods and may space the purchased months out by any desired interval, such as a quarterly interval.

In one embodiment, when it is time to roll the index because the front month is approaching the delivery date (or final settlement/expiration date), the front month is sold while the next month after the last month in the index is purchased. The daily price of the index may be based upon an average of the settlement prices for each futures contract included in the index. These prices may be calculated or based upon available daily settlement prices for the respective futures contracts from the exchanges upon which the futures contract is traded. The price of the index is then preferably calculated as an average of the calculated or received settlement prices for each future contract included in the index.

Using the above 12-month example, the January 2007 contracts would be sold and replaced by the purchase of January 2008 contracts. In this way, the index can be rolled indefinitely. Moreover, in the present example, because the number of contracts owned by the index is spread among 12-months, the number of contracts that must be bought and sold is approximately 1/12th of the total number of contracts in the index. It will be understood that the first month of the multi-period index need not be nearest delivery month for the futures contract(s) included in the index. The start of the multi-period index may begin at any number of forward months. For example, if the current date was Jan. 1, 2007, the first month of the index may be selected to be 3-months forward or the April 2007 futures contract. This selection may depend on the shape of the futures curve at a given point in time. For example, the start of the index, as well as the number of months included in the index, may be selected to span a flatter portion of the futures curves so as to advantageously future reduce the roll effects. Referring back to the structure of the multi-period index, the decrease in the number of contracts that are bought and sold may advantageously decrease the number of contracts as a proportion of open interest in the subject commodity and, therefore, the respective price pressures. Thus, in this way, enlargement of the spread between the current month and the new month being rolled into can be reduced, thereby reducing the effect of the roll on the price of the index. Weighting of the futures contracts across two or more months depending on the shape of the futures curve at any given point in time may further mitigate the roll effect. It will be recognized that due to the flexibility in both structuring and trading the financial product of the present invention, one can take advantage of both up and down markets for the specified financial product or basket, as well as take advantage of both contango and backwardated futures markets.

In another embodiment, the number of months to be rolled can be specified as a proportion of the number of months in the index. For example, in a 12-month index, the roll can be structured such that 3-months (or ¼th of the index) are rolled at one time. By increasing the number of months to be rolled, the investor can weight the index toward the front months to take advantage of speculative increases in the spot month if the investor is long the index, for example. This weighting can also be adjusted on a daily basis to account for changes in the futures curve. For example, as opposed to holding ¼th of the number of contracts in a 4-month multi-period index, depending on the shape of the futures curve for the particular instruments in the index, it may be advantageous to weight the holdings such that, by way of example only, 40% is held for the first month, 25% for the second month, 20% for the third month, and 15% for the fourth month. These weightings may be changed on a daily, weekly, or monthly basis to suit the needs of the index. A further example of the operation of such a weighted index is described below in connection with Table I(b).

In another alternate embodiment, the multi-period index can be rolled on a daily basis to further mitigate the effect of the roll. In such an embodiment, if the multi-period index was rolling from JAN07 contracts to JAN08 contracts, for example, the roll could be accomplished by rolling a fraction of the total number of JAN07 contracts into JAN08 contracts on each business day of the month in which the roll was taking place or some selected fraction of the number of business days of that month. For example, if JAN07 contracts were being rolled in DEC06, and December 2006 had 20 business days, for illustration only, then 1/20th of the number of JAN07 contracts could be rolled on each of the 20-days of December 2006. This feature could also be advantageously combined with the weighting feature of the futures contracts discussed in the prior paragraph.

In addition to, or in combination with, the above-referenced index, a cumulative rolling differential (CRD) is also disclosed. In general, in accordance with a preferred embodiment of the present invention, an index, and related tradable or issuable financial instruments, are priced, in whole or in part, by calculating a differential between two or more market states, such as is defined by time and/or location. For example, an index or financial instrument according to a preferred embodiment of the present invention can be created by tracking the differential between two forward months of a futures contract and rolling the differential forward at predetermined intervals for a definite time period or for an infinitely rolling period. The financial instrument moves up or down in value and/or results in one or more payments depending on a change in the differential between the two forward months of the selected futures contract. In lieu of actual payments based on changes in the cumulative rolling differential, the differential can be set against a starting benchmark, as described in greater detail below, so as to track increases or decreases in the cumulative rolling differential.

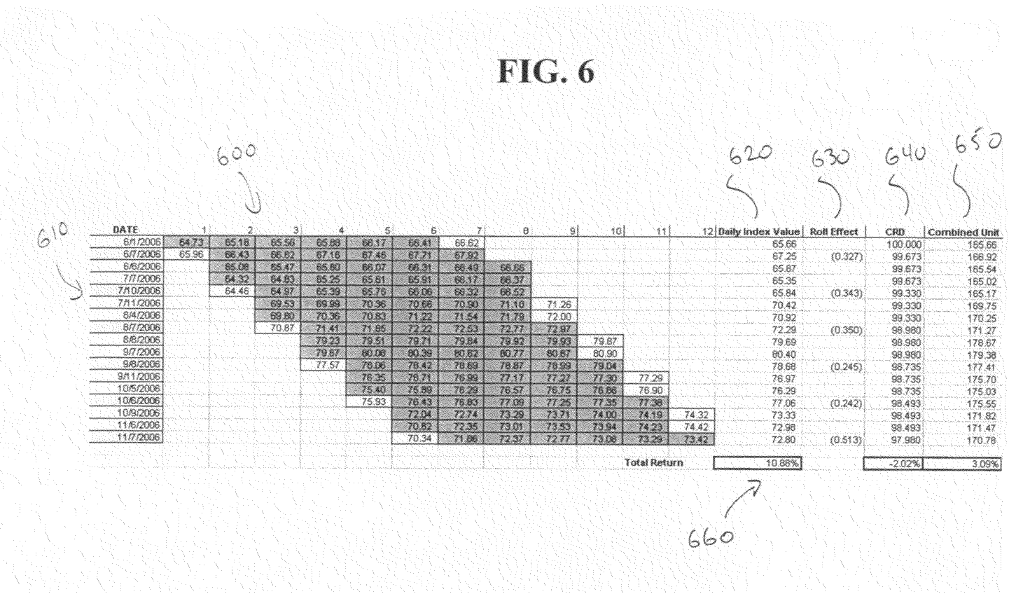

Moreover, the index or financial instrument, according to a preferred embodiment of the present invention, preferably rolls on a period-to-period basis, such as month-to-month in the present example, to preserve the differential which the financial instrument is designed to track. For example, in a six-month rolling index initially comprising JAN07 through JUL07, the cumulative rolling differential would track the roll from JAN07 into the AUG07 contract, and so on. Although, in the present example, the cumulative rolling differential is rolled on a month-to-month basis, the cumulative rolling differential may be configured to be rolled at other time periods or intervals such as on a daily basis. In an example provided below where the cumulative rolling differential is used to hedge or is combined with an existing multi-period index, the cumulative rolling differential preferably rolls forward to track the roll of the multi-period index. Thus, in a preferred embodiment, a multi-period and/or multi-location rolling index may be coupled with the cumulative rolling differential as a security so as to reduce, or in some cases, reducing the effect of the roll on the multi-period and/or multi-location rolling index, thereby providing a substantial “pure play” on the multi-period and/or multi-location rolling index. An example of a 6-month index in combination with a CRD mitigating the roll of the same is depicted in FIG. 6.

The cumulative rolling differential disclosed herein overcomes the shortcomings of known spread trading by providing a financial instrument that tracks a given spread and automatically rolls at a desired time period (e.g., month-to-month) to maintain the desired spread. The cumulative rolling differential may be created in any known or hereafter developed financial market, such as, by way of non-limiting example, commodities, equities, securities, derivatives, and other financial instruments. Moreover, in at least one embodiment, the cumulative rolling differential may be configured as a financial instrument, such as a security by way of non-limiting example, and bought or sold, traded, or used in a derivatives transaction either on an exchange or over-the-counter and, in either case, as a standalone financial instrument or embedded in another financial instrument, issued for use in derivatives transactions, or as a hedge to another financial instrument.

A method and system for managing a tradable commodities futures index such as has been described above is also provided. A computer system, for example, is programmatically designed to permit the creation, management, and clearing of the financial product of the present invention. By proving remote access to said computer system, clients can structure and invest in the financial product. The computer system may further enable the financial product to be managed such that daily, weekly, monthly, quarterly, or yearly mark-to-market pricing can be provided to clients (the time period being set as a matter of design choice). The computer system also preferably enables the automated rolling of the financial product, as described further herein, and preferably provides appropriate clearing functions.

Multi-Period Index

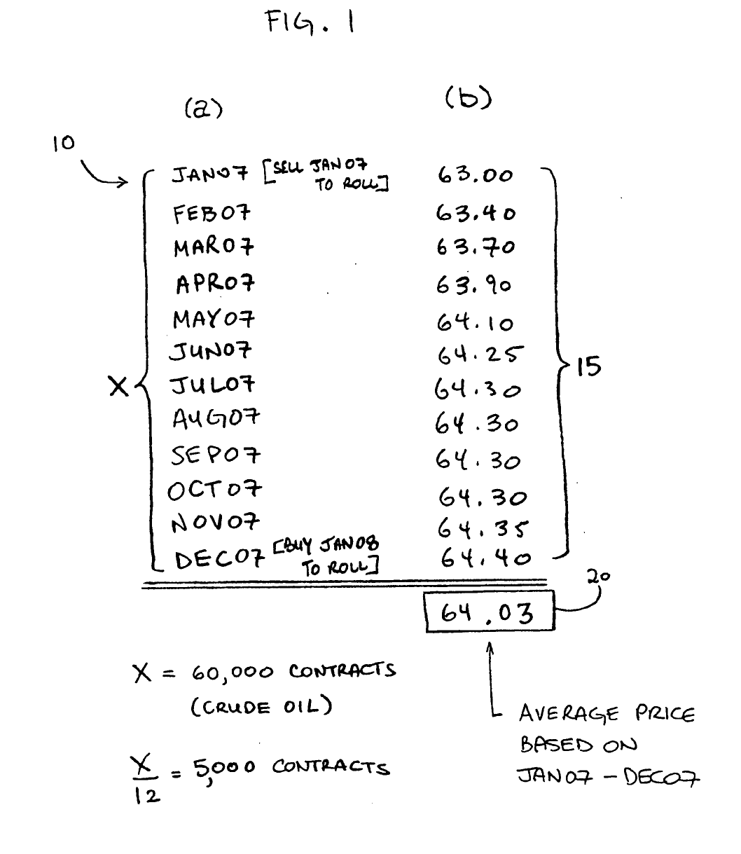

With reference now to FIG. 1, there will be shown and described various features of the preferred embodiments of a financial instrument comprising at least a multi-period index. As shown in column (a) of FIG. 1, a representative commodities index 10 comprises (X) number of futures contracts for a selected energy commodity for each month of a 12-month time period. The total number of futures contracts (X) is, in the present example, intended to be approximately split evenly between each month of the 12-month time period, and is represented as (X/12) number of contracts in FIG. 1.

With further reference to FIG. 1, as shown in column (b), at the close of the trading day on the exchange in which the applicable commodity is traded a closing settlement price is published. For example, the NYMEX and CME publish the settlement price for each commodity traded on its exchange at the end of the trading day. Generally speaking, the settlement price is not strictly the last traded price, but rather a price calculated using a weighted average of prices during a period of time at the end of the trading day. Using the prices shown in column (b) of FIG. 1, and average price of the index 10 can be derived by averaging the individual process comprising the index 10. In the example shown in FIG. 1, the index price 20 is calculated by first adding all of the prices 15 and dividing by the number of months 17 included in the index 10. In the case where the number of futures contracts that comprise the index 10 are weighted toward one or more months, the index price 20 is derived by calculating the weighted average of the prices, as is known in the art. It will be noted the method of calculating the settlement prices, e.g., the method used by the exchanges, used to calculate the instantaneous or daily value of the index is not critical to the practice of the invention.

Energy commodities and other perishable or consumable commodities, such as agricultural and farm products, are preferred for the financial product of the present invention. Other non-perishable commodity types such as precious and industrial metals, although less suitable to the present invention, may nevertheless be used in the index. A person of skill in the art will recognize that although the illustrative index of FIG. 1 is directed to a single commodity type, the index can be structured to include two or more commodity types in equal proportions or weighted as a matter of design choice. The preferred commodity types or one of or a mixture of the following commodities: crude oil, brent crude oil, gasoil, unleaded gasoline, jet fuel, natural gas, liquefied natural gas (LNG), propane, ethanol, heating oil, coal, and electricity.

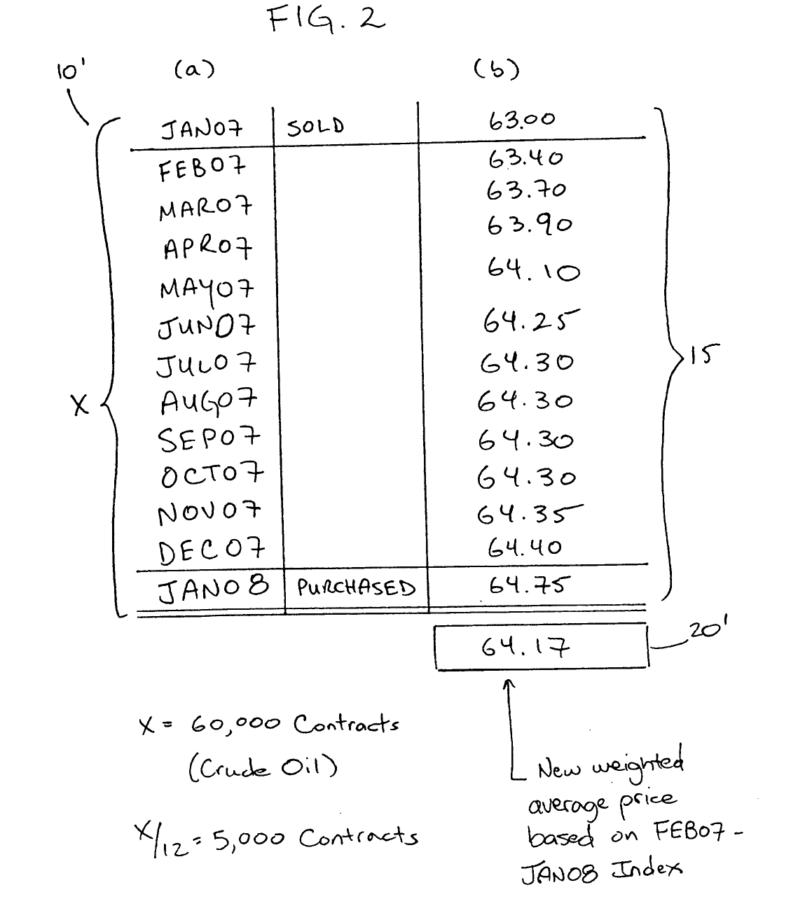

There will now be described a preferred method of rolling the index 10 from period-to-period such that a 12-month index is maintained. In the example of FIG. 1, the index 10 comprises futures contracts from January 2007 through and including December 2007. In order to maintain the 12-month rolling period of the index, the most current month, January 2007, must be sold and a new month at the end of the index period must be purchased. Thus, as further shown in FIG. 2, contracts from January 2007 are sold and contracts from January 2008 are purchased. The cost to the index 10 to accomplish the roll is the difference between the price of January 2007 and January 2008 contracts, commonly known as the spread. In a contango market, because the successive prices of futures contracts increases month-to-month. In a contango market, the cost of the roll will be negative to the price of the index, thereby making the cost to own the index more expensive. This is referred to as negative roll. In an example, the spread is $2.40 and the average index price 20′ increases. In a market that is in backwardation, the index will experience positive roll wherein the selling price of the current month will be greater than the purchase price of the forward month. Although not shown in the FIGS., under such conditions, the spread between the current month and the forward month may cause the index price to decrease.

Due to the flexibility in trading the index of the present invention, one can take advantage of contango or backwardation markets, as well as other market conditions, for example, by establishing short or long positions. Flexibility is also provided in that an investor can invest in different variations of the index, such as by way of non-limiting example, going long in a 60 month rolling index for crude oil and shorting the 12-month version of the crude oil index. The index 10 may alternatively be structured such that more than one month rolls. For example, in a 12-month index 10′, a quarterly roll may be adopted. In this example, 3-months of the 12-month index are rolled at the same time, as opposed to rolling only a single month. In this alternate embodiment, the January, February, and March 2007 contracts are sold and the January, February, and March 2008 contracts are purchased to preserve the 12-month term of the index 10′. This has the effect of increasing the bias of the index toward the front month and increasing the investor's exposure in a controlled manner to spikes in the spot price of the underlying commodity or commodities.

Of course, one skilled in the art will recognize that the number of months to be rolled can be selected as a matter of design choice and may comprise any desired proportional subset of the index term as desired. By way of example only, 1/12th, ⅙th, ¼th, or ½ the term can be rolled. Moreover, the front month of the index need not be in the nearest delivery month, but may be pushed forward to take advantage of one or more features of the futures contract curve.

In rolling the index 10′, because the total number of futures contracts in the index is divided among the 12-months of the index 10′, the total number of futures contracts that must be rolled to the forward month is 1/12 of the total number of contracts. This novel approach advantageously reduces the effect of increasing the spread between the current month and the forward month in contango markets due to the roll. To illustrate the advantageous effect, reference will be made to another example. In the present example, the hypothetical current month, which will be sold, is priced at $60 per contract, while the forward month, which will be purchased, is priced at $65 per contract. This illustrates a contango market in which there is a spread of $5 per contract. If a $5 spread is maintained, then the index will realize a negative roll delta of $0.42 per contract. However, in the case of the prior art indexes that are weighted toward the current month, when the current month's contracts are sold, the selling action tends to place downward pressure on the price of the contract. Thus, the average selling price of the current month's contract may be below $60; in the example, shown as $58. On the other hand, when the forward month's contracts are purchased, the buying action tends to place upward pressure on the price of the contract. Thus, the average purchase price of the forward month's contract may be above $65; in the example, shown as $67. The effective spread, therefore, has become $9 and the negative roll delta is $4 per contract above the spread.

In contrast, in accordance with a preferred embodiment of the present invention, only 1/12 or 8.33% of the total number of contracts is rolled. Because the number of contracts is substantially smaller as compared to the open interest of the commodity (or commodities) in question, the effect of the selling and buying actions to effect the roll are substantially reduced. As shown in the example, the selling action only reduces the average selling price of the current month to $59.75, and the buying action only increases the average buying price of the next month at the end of the index period to $65.25. Thus, the negative roll delta is advantageously reduced to $0.50—a reduction of $3.50.

The index, and related financial products, also advantageously provide transparency to the investor in that, as detailed above, the price of the index can be calculated using a simple weighted average of the settlement price. As such, the index and financial products can be priced mark-to-market on a daily basis. Additionally, the index can be marked-to-market intraday using the “last trade” price for each commodity included in the index.

The pricing of the index and related financial products are related to the pricing of the underlying commodities futures contracts upon which the index is based. Futures contracts on the index or financial products can also be created and traded. The index and financial products are advantageously structured so as to increase position flexibility and reduce exposure to market fluctuations. The present invention may further include a financial instrument that indexes to a market differential, as described further below.

Cumulative Rolling Differential

In accordance with a preferred embodiment of the present invention, a cumulative rolling differential tracks one or more spreads and is designed to be a financial instrument that can be bought or sold as a unit without buying or selling the underlying spread transactions. Moreover, the cumulative rolling differential preferably automatically rolls such that new cumulative rolling differentials need not be created each month to track a desired spread. In this way, the cumulative rolling differential provides an investor a new opportunity to speculate or hedge the price of the underlying instruments in a single transaction, where performing the same transactions without the index would require numerous separate transactions. The particular configuration of the cumulative rolling differential, for which several examples are disclosed below, can be modeled depending on the unique objectives of the investor.

As used herein, the term “time” refers to the selection of two or more months. For instance, in one example, a futures contract may be selected in a first month (e.g., July 2006) and a second month forward in time as compared to the first month (e.g., July 2007). Further, as used herein, the term “location” generally refers to the selection of two or more locations for which a commodity, for example, is delivered. For instance, the cumulative rolling differential of the present invention can be configured to comprise a first location where the underlying commodity is traded (e.g., Louisiana—Henry Hub for natural gas) and a second location (e.g., West Texas—Waha (EPGT) Texas Hub for natural gas) in which the at least two locations trade separately. As a further example, the cumulative rolling differential of the present invention may also be configured by including two or more locations at which electricity is priced. A person of ordinary skill in the art will recognize that any two or more time periods or locations can be selected and/or combined to meet certain needs or criteria. In yet another embodiment, a cumulative rolling differential may be created by including one or more differentials across different product types, such as comparing the price differential between an energy commodity and an agricultural commodity.

In another preferred embodiment of the present invention, a cumulative rolling differential may be configured by selecting two or more time periods, as well as a different location for each of the selected time periods. Thus, by way of example, the cumulative rolling differential can comprise Henry Hub natural gas for July 2006 and Waha (EPGT) Texas Hub natural gas for September 2006. As with other configurations, the cumulative rolling differential is priced by calculating the change in the differential between the two futures contract, as shown below.

The table below illustrates the general concept:

TABLE I(a)

| INDEX MONTH | PRICE | QUANTITY (Contracts) |
|---|---|---|
| JAN07 | 70.00 | 12000 |
| FEB07 | 69.75 | 12000 |
| MAR07 | 69.25 | 12000 |
| APR07 | 68.00 | 12000 |
| MAY07 | 67.50 | 12000 |
| JUN07 | 67.00 | 12000 |
| JUL07 | 65.85 | 12000 |
| AUG07 | 65.25 | 12000 |
| SEP07 | 63.50 | 12000 |
| OCT07 | 62.25 | 12000 |
| NOV07 | 60.50 | 12000 |
| DEC07 | 59.00 | 12000 |
| JAN08 | 58.00 | 12000 |

In the example of Table I(a), the price of the 12-month index is the weighted average of the prices for the months JAN07 through DEC07, and is $65.65. In order to maintain the index from month-to-month the index must be rolled by selling 12000 JAN07 contracts and purchasing 12000 JAN08 contracts. In this example, the differential between the JAN07 contracts and the JAN08 contracts is $12. Thus, by selling the $70 JAN07 contract and purchasing the $58 JAN08 contract, the index will realize a decrease of 1/12th the difference between the two contracts, or $1.

The new price of the index after the roll is therefore $64.65. In market terms, the decrease in the index value due to the roll may be paid to the investor in a form similar to a dividend. Given the relative prices of the contracts comprising the index of Table I(a), the roll is positive due to the backwardated pricing of the futures contracts, and, all other things being equal, the fact that the index went down in price or vice versa. In a contango market, as described above, the index of Table I(a) would have experienced a negative roll and, although the index price would have increased, the investor would have realized a type of negative effect or dividend.

In order to reduce or minimize the effect of the roll, the cumulative rolling differential of the present invention can be configured to comprise the differential between the JAN07 and JAN08 contracts. In this example, if the investor is long the index, then the cumulative rolling differential is in essence shorted or, put mathematically, the cumulative rolling differential is the negative of the differential between the JAN07 and JAN08 contracts. Of course, persons of skill will recognize that reverse positions can be taken. Thus, using the example shown in Table I(a) above, whereas the index realizes a $1 decrease, the cumulative rolling differential will realize a relative $1 increase based on the differential between the JAN07 and JAN08 contracts.

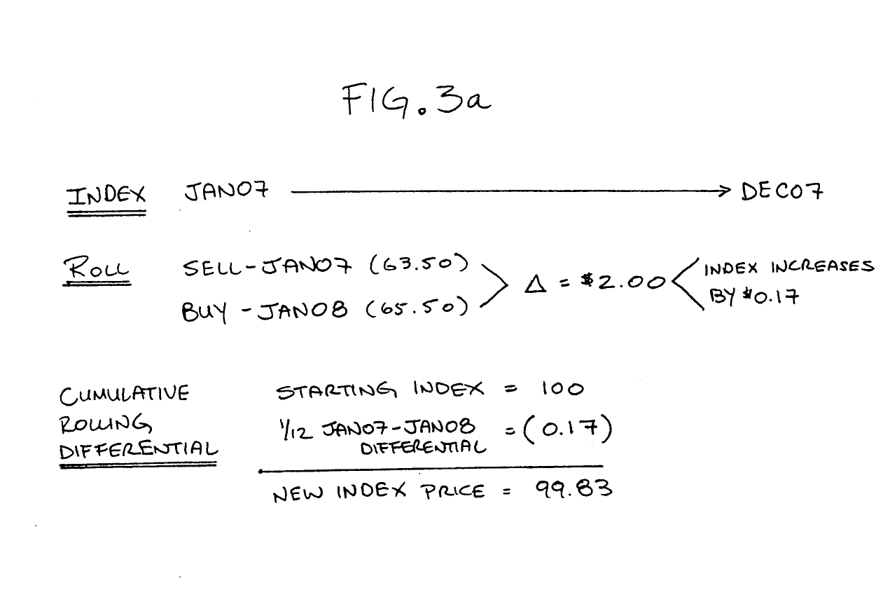

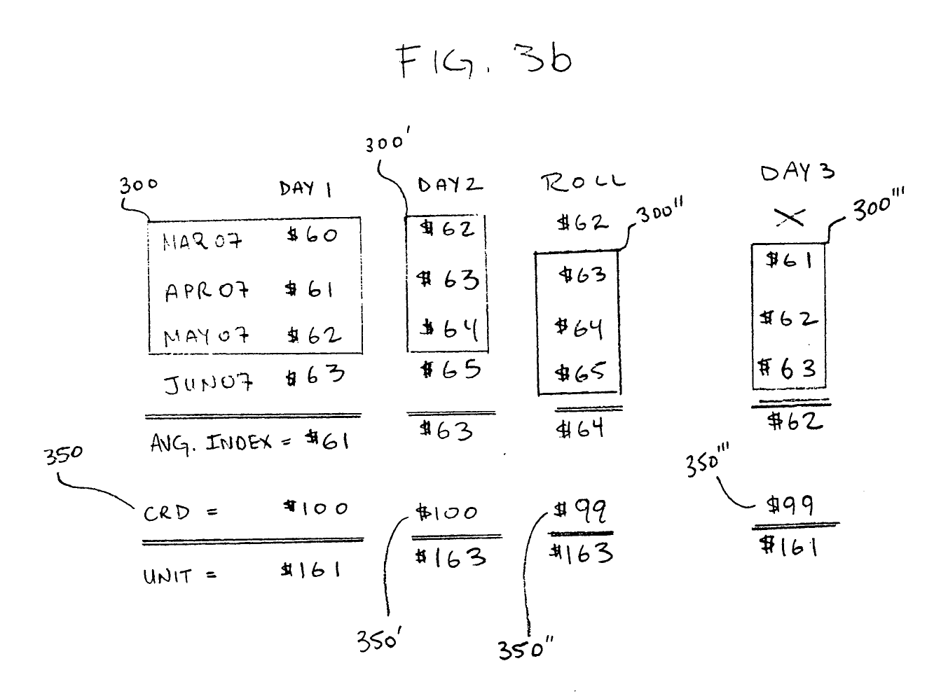

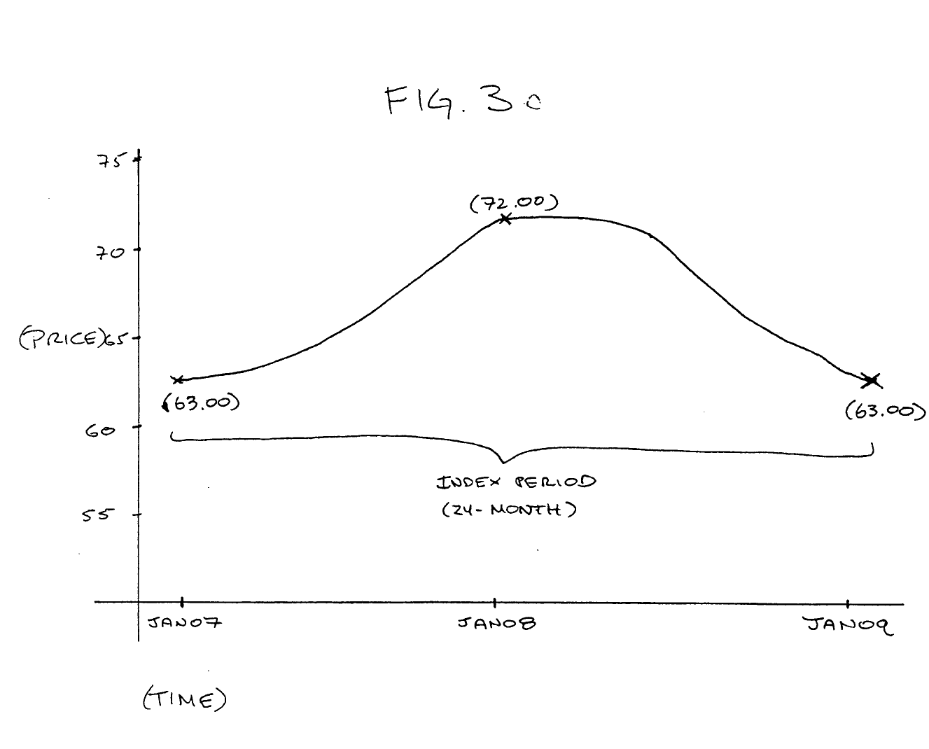

FIG. 3a further illustrates the general operation of the CRD in combination with a multi-period futures contract index, as described above. Specifically, with an index such as is disclosed above in connection with FIG. 1, it may be desirable to reduce the effect of the roll (whether positive or negative) of the index, so that a value of the index can be at least partially divorced from the effects of the roll. This is because a person may desire to invest solely in the rise and fall, as applicable, of the index due to the rise and fall of the underlying index components. Thus, in the example shown in FIG. 3a, the cumulative rolling differential may be configured such that it comprises the differential between the first month of the index and the next month to be purchased during the roll, as shown in the Figure. In this case, the cumulative rolling differential would track the differential between the January 2007 futures contract (i.e., the first month of the index to be sold) and January 2008 futures contract (i.e., the next month of the index to be purchased).

In the simple example shown in FIG. 3a, the CRD appears to offset the increase in the index price due to the roll. However, it should be recognized that the cumulative rolling differential does not entirely negate the effect of having to roll the multi-period index. In FIG. 3b, a three-month multi-period index 300 in crude oil is shown. The three-month index 300 has prices of $60, $61, and $62 for the three-month period MAR07 through MAY07 and, therefore, an average index price 305 of $61. The JUN07 contract is priced at $63. In the example being shown, the CRD index 350 is initially benchmarked or valued at $100, although other starting values may be used as described further below. At this point in time, the combined value of the index 300 and the CRD index 350 is $161. On the day that the index 300 is to roll, the underlying commodity prices have risen by $2 such that the index 300 has prices of $62, $63, and $64 and an average price of $63. The JUN07 contract has also risen $2 to $65. The combined value of the index 300 and the CRD index 350 is now $163.

With further reference to FIG. 3b, to roll the index 300, the MAR07 contracts are sold and the JUN07 contracts are bought. Thus, the index 300′ now comprises the APR07, MAY07, and JUN07 contracts at an average price of $64. The CRD index 350′, which had an initial value of $100, is adjusted by the negative of ⅓ of the delta between the MAR07 contract and the JUN07 contract such that the change in the CRD is calculated, as follows:

$$Δ CRD = - \frac{1}{\# Index Months} \times Δ Roll$$

In this example, the delta between the MAR07 contract and the JUN07 contract is $3 and so the change in the CRD is −$1. Thus, the resulting respective values of the index 300″ and CRD 350″ are $64 and $99 for a combined value of $163.

If at a later point in time, prior to the next roll, the APR07, MAY07, and JUN07 contracts have an average price of $62, the combined value of the index 300′″ and CRD 350′″ will have a value of $161. In this scenario just described, the underlying index price has risen $1, but the overall value of the combined unit of the index and CRD has remained flat. This effect, however, is deceiving because in the absence of the CRD it would have cost $3 to roll into the JUN07 contracts. Thus, whereas the combined unit remained flat, the index by itself would have lost $2 in value as a result of the cost to carry the index through the roll, thereby creating a gain of $1 from the underlying futures contract prices and a loss of $3 from the negative roll. As such, the combined unit of the Index 300 and the CRD 350 effectively mitigates the cost to carry the index through one or more roll periods.

Referring now to FIG. 6, there is shown a chart depicting the valuation of an index and CRD in accordance with an embodiment of the present invention using hypothetical historical prices for crude oil. The index is a 6-month rolling index 600. The monthly contracts included in the index 600 are shown in the dark gray shaded boxes. The lightly gray shaded boxes 610 depict the day on which the index 600 is rolled onto the next nearest delivery month. One skilled in the art will recognize, however, that index 600 could alternatively be structured to roll on a daily basis, weekly basis, or other selected time basis. Moreover, the roll of the index can be spread over two or more days, such as rolling ⅕th of the contracts on each of five consecutive days. Column 620, entitled “Daily Index Value,” depicts the daily value of the index 600. Column 630, entitled “Roll Effect,” depicts the cost/gain due to the roll on the day the roll is performed. In this example, where the market is in contango, the roll effect reflects a cost to carry. Column 640, entitled “CRD,” depicts the rolling value of the CRD as a result of the roll effect. Column 650, entitled “Combined Unit,” depicts the value of the CRD 640 combined with the multi-period index 620. Row 660 depicts the return values for the index 620, CRD 640, and Combined Unit 650. It will be understood that the return of the Index 620 is the simple return exclusive of the roll and, therefore, not indicative of the return that would be realized if only the index 620 was held. In such a case, the return of the index 620 would include a carrying cost in a contango market, thereby reducing the return.

In an alternate embodiment, where the multi-period rolling index is weighted, the cumulative rolling differential must also be weighted in order to properly reduce the roll effect. Table I(b) shows an example of a weighted multi-period rolling index:

TABLE I(b)

| INDEX | | QUANTITY | QUANTITY |
|---|---|---|---|
| MONTH | PRICE | (Contracts prior to Roll) | (Contracts after Roll) |
| JAN07 | 70.00 | 12000 | None |
| FEB07 | 69.75 | 12000 | 12000 |
| MAR07 | 69.25 | 12000 | 12000 |
| APR07 | 68.00 | 12000 | 12000 |
| MAY07 | 67.50 | 8000 | 12000 |
| | | | (4000 contracts added) |
| JUN07 | 67.00 | 8000 | 8000 |
| JUL07 | 65.85 | 8000 | 8000 |
| AUG07 | 65.25 | 8000 | 8000 |
| SEP07 | 63.50 | 4000 | 8000 |
| | | | (4000 contracts added) |
| OCT07 | 62.25 | 4000 | 4000 |
| NOV07 | 60.50 | 4000 | 4000 |
| DEC07 | 59.00 | 4000 | 4000 |
| JAN08 | 58.00 | None | 4000 |

As can be seen in Table I(b) above, the rolling index comprises 12-months of futures contracts in which the first 4-months comprise 12,000 contracts, the second 4-months comprise 8,000 contracts, and the last 4-months, comprise 4,000 contracts. When this index is rolled, the 12,000 contracts of JAN07 are sold and replaced by 4,000 contracts of JAN08. In addition, the first month of the second 4-months of the rolling index must now be stepped up to 12,000 contracts as shown. Similarly, the first month of the third 4-months of the rolling index must now be stepped up to 8,000 contracts as shown. The weighted average pricing and the resulting change due to the roll is calculated using known weighted averages. In order to reduce the effect of the roll of the index, the cumulative rolling differential must be weighted accordingly. In the present example, the cumulative rolling differential may be structured such that the cumulative rolling differential tracks (i) the differential between 4000 of the JAN07 contracts and 4000 of the JAN08 contracts, (ii) the differential between 4000 of the JAN07 contracts and 4000 of the contracts in the first month of the second 4-months of the rolling index (e.g., MAY07), and (iii) the differential between 4000 of the JAN07 contracts and 4000 of the contracts in the first month of the third 4-months of the rolling index (e.g., SEP07). Because the cumulative rolling differential tracks the change in 1/12th the overall number of contracts in the rolling index, the components of the cumulative rolling differential must therefore be adjusted by a weighting factor, as illustrated below.

This weighted differential can then be used to reduce the roll effect in a weighted multi-period index, as follows: This initial weighted average price of the index shown in Table I(b) is approximately $66.97708. The roll shown in Table I(b) causes the weighted average price of the index by $0.875 to approximately $66.10208. Because the first month in the rolling index of Table I(b) is ⅛th of the total number of contracts in the index, the weighting factor for the cumulative rolling differential is “8”. Thus, with reference to FIG. 2, the change in the cumulative rolling differential is calculated as follows: ((A−B)+(A−C)+(A−D))/3 divided by a weighting factor of T/A′ or, in this example, 8. ((70−67.5)+(70−63.5)+(70−58))/3=21. 21/8=0.875.

A preferred embodiment of pricing a multi-month index coupled or sold with a cumulative rolling differential as a security will now be described. One component of the price of the security is the price of the multi-month index. This price is based on the components that make up the multi-month index. In one embodiment, the price of the multi-month index is based on a weighted average of the futures contracts for each commodity and each month in the index. An example of such a multi-month index is described below and shown in Table II. Another component of the price of the security is based on the price of the cumulative rolling differential. The price of the cumulative rolling differential is preferably based on a factor designed to maintain a price for the cumulative rolling differential above zero.

In pricing the initial value of the cumulative rolling differential coupled to the multi-month index, one factor preferably is to account for the potential for negative roll in the month-to-month rolling of the cumulative rolling differential. Other factors such as demand for the security, expectations of future market conditions and the like may also be considered in pricing the cumulative rolling differential. To illustrate, if the cumulative rolling differential is to exist for 5-years, then the starting price of the cumulative rolling differential would preferably account for the potential for negative roll in the corresponding multi-period index over the course of the 5-years. As described above, negative roll occurs when the market for the underlying commodity(ies) is in contango. If contango market conditions persist throughout the life of the cumulative rolling differential, then there is the potential that the benchmark price of the cumulative rolling differential will continue to decrease until it reaches zero. In the present scenario where the multi-month and cumulative rolling differential are being tracked as a combined index or sold as a combined security, the price of the cumulative rolling differential portion of the combined security preferably should not go below zero, especially if it is to be separately salable and/or tradable as a security from the multi-month index. If it does, then the cumulative rolling differential may cease to be an effective tool for reducing the effect of negative roll on the price of the security.

One way of increasing the probability that the price of the cumulative rolling differential will remain above zero throughout the life of the security is to set the initial benchmark price of the cumulative rolling differential at a high enough level as compared to the potential for negative roll. This benchmark price may be realized by looking at historical data for the underlying commodity(ies) to determine the amount of negative roll that may be realized over the course of the life of the security. The amount will depend on the configuration of the cumulative rolling differential both as the nature and type of financial instruments included in the index and as to the number of months comprising the multi-month index.

By way of example, if the price of the multi-month index is initially at $70 and the benchmark price of the cumulative rolling differential is set at $70, then the combined cost of the security is $140. If after the first month's roll in a contango market, the multi-month index increases in price by $1, then the benchmark price of the cumulative rolling differential will decrease by $1. Thus, the roll effects is reduced because the overall cost of the security remains at $140. The roll effect of the multi-month index will continue to be reduced by the cumulative rolling differential, as described above, until and unless the price of the cumulative rolling differential reaches zero due to negative roll. If the cumulative rolling differential reaches zero and the next month's roll is also negative, then the cumulative rolling differential will go negative or remain at zero, as a function of the security tracking the CRD, while the price of the multi-month index will continue to rise due to the roll. While this condition is not preferred, an entity may chose to price the cumulative rolling differential lower in order to provide at least partial protection from negative roll at a more attractive selling price. In this way, the cumulative rolling differential can be thought of as a sort of partial insurance against negative or positive roll.

In a preferred embodiment, the initial valuation of the CRD may be derived at least in part from (i) the time value of money needed to purchase the combined asset of the index and CRD, such as if the money was invested in treasuries or some other interest bearing account, (ii) the expected return of the underlying commodity over a selected period of time, and (iii) the expected negative roll over such period of time. In this embodiment, the CRD value would preferably be set sufficiently high such that negative roll over the selected time period would not drive the value of the CRD to zero or below. The CRD would also preferably be set at a sufficiently low value such that a return greater than the expected return of the underlying commodity over that time period could be potentially realized.

In another alternate embodiment, the CRD index may be benchmark priced initially at zero. In this way, the cumulative rolling differential may be indexed as part of the multi-month index without regard to whether the value of the cumulative rolling differential in negative or positive. In the instances where a security is created to track the CRD, the combined unit of the multi-period index and the CRD may be sold for a premium price that is not tied directly to any index price of the cumulative rolling differential. The index level, whether zero or above or below zero, therefore, serves to reduce the roll effect of the multi-month index by adding the price of the multi-month index after the roll to the index level of the cumulative rolling differential after the roll.

In another preferred embodiment, the cumulative rolling differential is configured by including two or more locations, such as Louisiana, Henry Hub and West Texas, Waha (EPGT) Texas Hub. The price of natural gas can differ from location-to-location. A cumulative rolling differential can, thus, be configured to track the change in this differential. For example, Henry Hub gas may trade at $5.12 per MMBtu, while Waha Texas Hub gas may trade at $4.92 per MMBtu—a difference of $0.20 per MMBtu. Thus, the cumulative rolling differential would track the change from day-to-day in the delta between the two locations for natural gas delivery. This type of cumulative rolling differential can be used to hedge other transactions, to speculate on the widening or narrowing of the differential, or as a component of a derivatives transaction. For example, a derivative swap can be created by having one party swap the Henry Hub/Waha Texas Hub cumulative rolling differential for a cumulative rolling differential created from two different locations and/or time periods. This sort of swap could also be used with a cumulative rolling differential created solely from using two or more time periods for a particular futures contract.

In yet another preferred embodiment, a cumulative rolling differential may be configured by including two or more commodity types into a weighted index. For example, an energy-based cumulative rolling differential would preferably include differentials for crude oil, brent crude oil, gasoil, unleaded gasoline, jet fuel, natural gas, liquefied natural gas (LNG), propane, ethanol, heating oil, coal, and electricity. Persons of skill will recognize that the type and number of commodities included in the cumulative rolling differential is not limited and may include any number or type of commodity. The differentials may be structured, for example, by calculating a weighted average of differentials for a given time period. For instance, as illustrated in Table II below, the chosen time differential is 3-months:

TABLE II

| | 1st Time | 2nd Time | | |
|---|---|---|---|---|
| Commodity | Period | Period | Price Delta | Weight |
| Crude oil | JUL06 | OCT06 | +2.040 | 75% |
| Natural Gas (HH) | JUL06 | OCT06 | +1.088 | 7% |
| Electricity (NY) | JUL06 | OCT06 | −0.875 | 5% |
| Unleaded Gasoline | JUL06 | OCT06 | −0.254 | 4% |
| Ethanol | JUL06 | OCT06 | +0.058 | 4% |
| Heating Oil | JUL06 | OCT06 | +0.097 | 2% |
| Jet Fuel | JUL06 | OCT06 | −0.068 | 1% |
| LNG | JUL06 | OCT06 | +0.354 | 1% |
| Propane | JUL06 | OCT06 | +0.029 | 1% |
| INDEX PRICE | | | +1.559 | 100% |

As shown in Table II above, an index of price differentials between two time periods for a plurality of commodities can be created. To maintain the cumulative rolling differential of Table II, the differential of the cumulative rolling differential is preferably rolled from month-to-month. The price of the cumulative rolling differential is calculated using a weighted average of the price deltas for each of the commodities. It will be understood that the particular type and number of included commodities, the industry, and the weighting shown are merely for illustrative purposes and not to be construed to limit the scope of the present invention. Like the other embodiments disclosed herein, the weighted cumulative rolling differential can be traded as a standalone financial instrument or embedded in a financial instrument or other type of transaction.

With reference to the example of Table II, another cumulative rolling differential can be created to reduce the effect of the roll of the 3-month spread index by configuring an index that tracks the delta between the first month (JUL06) and the month to be rolled into (NOV06). This type of cumulative rolling differential would work as described above.

In an alternate preferred embodiment, both the multi-period index and the cumulative rolling differential are configured such that the period of the index tracks the part of the futures contract curve where the price differential between the first and last months of the index is at least initially zero. FIG. 3d illustrates this concept. In this way, although portions of the curve for the selected index period may be in contango or backwardation, the initial first to last month differential is zero.

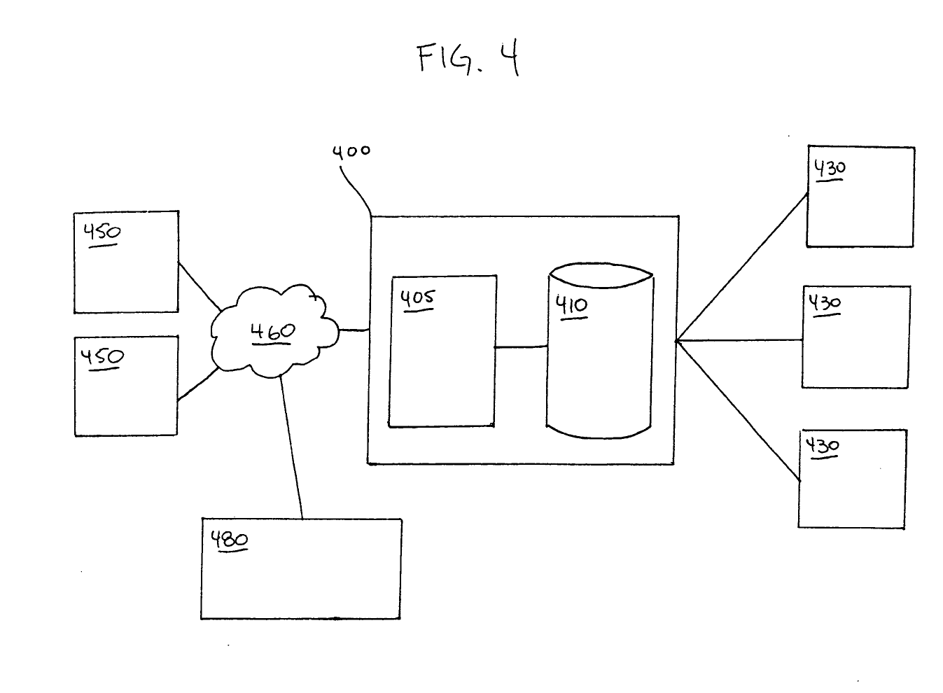

With reference to FIG. 4, there will now be described a preferred embodiment of a computer system 400 for managing the creation and operation of the financial product of the present invention. A computer system 400 includes a centralized computer system 405 capable of communication with one or more investor databases 410. Computer system 405 generally includes one or more computers that are programmatically structured, as detailed below, to perform the functions required to manage the creation and operation of the financial product of the present invention. One skilled in the art will recognize that the server system may as a matter of design choice include any number and configurations of computers and databases, which may be used separately or in tandem to support the traffic and processing needs necessary in operation at one time. In the preferred embodiment, computer system 405, if multiple computers are used, is configured using a round-robin configuration to handle end user traffic. Although not depicted in the figures, the one or more computers of computer system 405 generally include such art recognized components as are ordinarily found in such computer systems, including but not limited to processors, RAM, ROM, clocks, hardware drivers, associated storage, and the like.

Furthermore, each of the computer systems described herein preferably includes a network connection (not shown). The network connection may be a gateway interface to the Internet or any other communications network through which the systems can communicate with other systems and user devices. Network connection may connect to the communications network through use of a conventional modem (at any known or later developed baud rate), an open line connection (e.g., digital subscriber lines or cable connections), satellite receivers/transmitters, wireless communication receivers/transmitters, or any other network connection device as known in the art now or in the future.

Computer system 405 is preferably programmatically structured to effectuate the rolling process described above. In a preferred embodiment, computer system 405 can be in communication with one or more trading counterparts 430 to permit rolling of the financial product. In this way, the computer system 405 can be set to cause the selling of the first month's futures contracts and the buying of the last month's futures contracts of the index at a specified time. Of course, one skilled in the art will recognize that the trades necessary to effect the roll can be performed by live traders in whole or in part, as applicable.

With reference again to a preferred embodiment, computer system 405 is capable of communication with one or more client systems 450 via a network 460. In a preferred embodiment, the network 460 is a publicly available network, such as the World Wide Web. By communicating with clients 450, computer system 405 can provide access to account management and mark-to-market pricing functions to investors. To this end, computer system 405 is preferably programmed to provide a number of graphical user interfaces (GUIs) to investors via client systems 450 such that investors can interact with and use the functions provided by computer system 405.

Additionally, computer system 405 is preferably capable of communication with an exchange system 480 via network 460. Exchange system 480 preferably provides a data feed of “real-time” or daily settlement prices to computer system 405. For example, real-time and/or settlement prices can be electronically communicated to computer system 405 at specified intervals, such as hourly or at the end of the trading day.

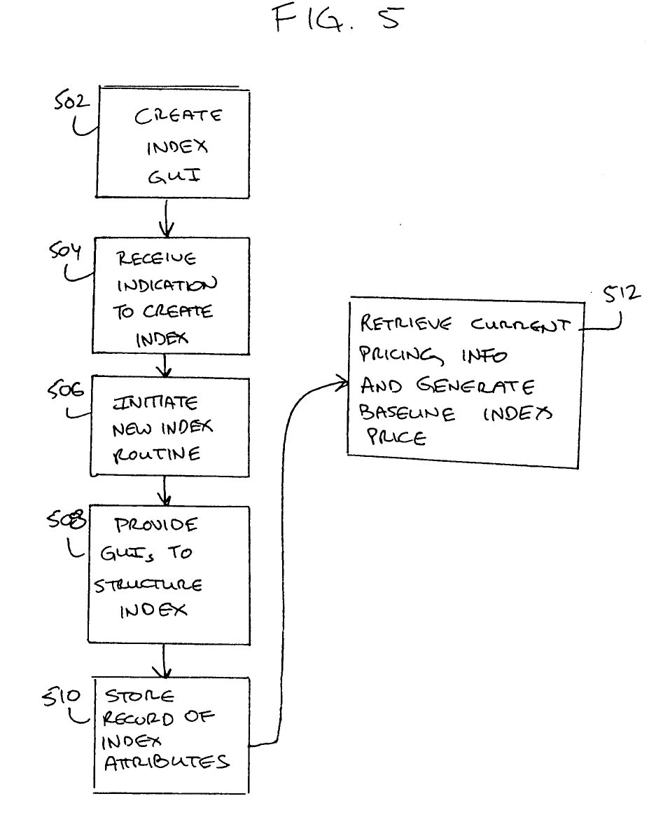

A preferred method of managing the daily pricing of the financial product described herein will now be described with reference to FIG. 5. In a step 502, computer system 405 provides a “Create Index” GUI to client system 450. In step 504, computer system 405 receives an indication from client system 450 that an investor desires to create a new index. In step 506, computer system 405 initiates a “Create Index” routine. In step 508, client system 450 is provided by computer system 405 with one or more GUIs permitting selection of one or more index attributes, such as, by way of non-limiting example, the number of futures contract months to be included in the index (e.g., 12-months), the commodity types, the weighting of commodities, and the number of months to be rolled. In step 510, once the index attributes are selected, computer system 405 stores a record of the index attributes in database 410. In step 512, computer system 405 retrieves current pricing information for the futures contracts included in the index and generates a baseline index price. The baseline index price can be used to calculate the relative value of the index price on any given subsequent date so as to provide investors with a gain/loss indication.

Financial Instruments—Structured Notes

One financial product that can be used with the Index and CRD are non-interest bearing structured notes linked to the Index and CRD. The structured notes may or may not be principal protected and would derive their value either from movement in the underlying value of the Index and CRD. In the preferred arrangement, two structured notes would be issued, one reflecting the value of the Index and one reflecting the value of the CRD. Each of these structured notes would be a direct unsecured obligation of an issuer.

The two notes would be at least initially clipped together and sold as a unit. Investors could later unclip the notes and sell or hold them as individual financial instruments. This feature is particularly advantageous because it enables the investor to take advantage of various market conditions. For instance, in existing futures contract based indices, an investor long the index will be subject to the roll—positive in a backwardated market and negative in a contango market. By holding two securities linked individually to the Index and CRD, the investor could advantageously sell one of the securities. Thus, in a backwardated market, the investor may desire to be exposed solely to the positive roll and might therefore sell the Index to take advantage of the increasing value of the CRD. It will be understood that in accordance with the various embodiments of the present invention investors may buy, sell, or trade the securities linked to the Index and CRD in any number of ways to take advantage of market conditions. Moreover, in certain arrangements, the could take either long or short positions in the Index and/or CRD.

Because the structured note linked to the CRD could potentially have a negative value, it is preferred, but not necessary in all cases, that the structured notes linked to the CRD would include a feature to prevent a negative note value. The price of the CRD-linked structured note may, therefore, reflect an additional cost as a result of this feature.

It will be understood by those of skill in the art that the types of structured notes being described are not typical debt instruments. However, in an alternative embodiment, such as where at least a portion of the principal investment is protected, the interest bearing component of a more traditional note may be linked to the value of the Index and CRD.

Financial Instruments—ETF-Like Product

In another embodiment, the Index and CRD may be the basis upon which an ETF-like product is created. In this example, the issuer would issue two structured “notes” (referred to as “Master Notes”), in the form discussed above. The Master Notes would preferably be held by a first entity, e.g., a limited liability company (LLC). A second entity, e.g., a trust (Trust), would invest substantially all of its assets in the LLC. As such, the Trust would substantially track the combined value of the Index and CRD. The Trust would then issue creation units consisting of a large number of shares to authorized underwriters, who in turn resell those shares to investors. The Trust would preferably be structured such that there are two classes of shares—one series of shares reflecting an interest in the Master Notes tracking the Index and a second series of shares reflecting an interest in the Master Notes tracking the CRD. The two series of shares would preferably be “clipped” together and sold, at least initially, as a single unit comprising two units that could be separated at the time of resale. This would advantageously enable downstream investors to advantageously separate the Index-tracking unit from the CRD-tracking unit. The Trust shares could be listed on an exchange.

Within the scope of the present invention, alternative structures could be created to effect the indexing of the Index and CRD. For example, two separate LLCs could be created to each hold one of the structured notes issued by the issuer. In turn, two trusts could be created where each trust has as its asset an interest in one of the LLCs.

Financial Instruments—Derivatives

It is also within the scope of the present invention that various types of derivative instruments, such as, by way of non-limited example, swaps and futures contracts, could be created and based on, linked to, or designed to track in whole or in part the Index, CRD, or both.

As has been described, a multi-period index, cumulative rolling differential, and related financial instruments in accordance with the present invention has numerous transaction cost and other advantages, as well as providing increased investment possibilities and flexibilities to the investor. While there have been shown and described fundamental novel features of the invention as applied to the exemplary embodiments thereof, it will be understood that omissions and substitutions and changes in the form and details of the disclosed invention may be made by those skilled in the art without departing from the spirit of the invention.

I claim:

1. A method of calculating an index price for an index including a selected number of futures contracts for at least one futures type where the a selected number of futures contracts are spread among a selected time period including at least two expiration periods and wherein the selected time period is maintained by rolling the index at a roll period, comprises:
calculating a first index component price for the index for the selected time period by indexing values for the selected number of futures contracts for the at least one futures type included in the index;
calculating the index price by adding the first index component price to a second index component price wherein the second index component price is initially set at a first value;
recalculating the index price at least at each roll period by:
recalculating the first index price by indexing then current values for the selected number of futures contracts for the at least one futures type included in the index;
calculating a rolling differential value by determining a delta between a first price for the selected number of futures contracts for the at least one futures type that fall within a first period of the at least two expiration periods and a second price for the selected number of futures contracts for the at least one futures type that fall within a forward expiration period subsequent to a last expiration period of the at least two expiration periods;
adjusting the first value of the second index component price using the rolling differential value; and
calculating the index price by combining the first index component price and the second index component price.

2. The method of claim 1, wherein the selected time period is between two and 24 months.

3. The method of claim 1, wherein the at least two expiration periods includes an expiration period in each month of the selected time period.

4. The method of claim 1, wherein the at least two expiration periods includes an expiration period in each quarter year of the selected time period.

5. The method of claim 1, further comprising rolling the index by selling the selected number of futures contracts for the at least one futures type that fall within the first period of the at least two expiration periods; and buying an equal number of futures contracts to the selected number of futures contracts for the at least one futures type that fall within the forward expiration period subsequent to the last expiration period.

6. The method of claim 1, wherein the at least one futures type is at least one commodity futures contract.

7. The method of claim 6, wherein the at least one commodity futures contract is selected from the group consisting of energy commodity futures contracts, metal commodity futures contracts, agricultural commodity futures contracts, and soft commodity futures contracts.

8. The method of claim 1, wherein the at least one futures type includes a plurality of commodity futures contracts.

9. The method of claim 8, wherein the at least one futures type including a plurality of commodity futures contracts is selected from the group consisting of crude oil, brent crude oil, gasoil, unleaded gasoline, jet fuel, natural gas, liquefied natural gas, propane, ethanol, heating oil, coal, and electricity.

10. The method of claim 1, wherein the at least one futures type includes a plurality of equity futures contracts.

11. The method of claim 1, wherein the at least one futures type includes a plurality of foreign exchange futures contracts.

12. The method of claim 1, wherein the at least one futures type includes a plurality of bond futures contracts.

13. The method of claim 1, wherein the index includes a plurality of futures types and the selected number of futures contracts included in the index for each of the plurality of futures types is determined by a weighting factor, and the step of calculating the first index component price further comprises calculating an average price for the selected number of futures contracts included in the index for each of the plurality of futures types using the weighting factor.

14. The method of claim 1, wherein the selected time period for the index is twelve (12) months.

15. The method of claim 14, wherein the index includes the selected number of futures contracts in each of the twelve months of the selected time period and the index is rolled on a monthly basis.

16. The method of claim 14, wherein the index includes the selected number of futures contracts in each quarter of the twelve months of the selected time period and the index is rolled on a quarterly basis.

17. The method of claim 1, wherein the first index price component and second index price component are determined at least in part using futures contract prices derived from settlement prices for the at least one futures type.

18. The method of claim 17, wherein the settlement prices are provided by an exchange selected from the group consisting of the New York Mercantile Exchange, New York Board of Trade, Chicago Mercantile Exchange, Chicago Board of Trade, International Securities Exchange, London Clearing House, and Intercontinental Exchange.

19. An index, comprising:
a basket of futures contracts, the basket including at least two or more sets of futures contracts with different delivery months spread over a selected time period having a starting delivery period and an ending delivery, and wherein the basket of futures contracts is rolled as certain futures contracts in the basket approach expiration;
a roll differential component that indexes to a starting value periodically adjusted by a differential substantially equal in value to a delta between a first value of the futures contracts in the basket approaching expiration and a second value of futures contracts being rolled into a delivery period subsequent to the ending delivery period of the selected time period; and
wherein the index is priced at least in part based on index values of the basket of futures contracts and the roll differential component.

20. The index of claim 19, wherein the basket of futures products includes one or more commodities.

21. The index of claim 20, wherein at least one of the one or more commodities are selected from the group consisting of crude oil, brent crude oil, gasoil, unleaded gasoline, jet fuel, natural gas, liquefied natural gas, propane, ethanol, heating oil, coal, and electricity.

22. The index of claim 19, wherein the basket of futures products includes one or more equity futures contracts.

22. The index of claim 19, wherein the basket of futures products includes one or more bond futures contracts.

23. The index of claim 19, wherein the basket of futures products includes one or more foreign exchange futures contracts.

24. The index of claim 19, wherein the selected time period is between two and 24 months.

25. The index of claim 19, wherein the selected time period is a number of consecutive months.

26. The index of claim 19, wherein the selected time period is a number of consecutive quarters.

27. The index of claim 19, wherein the starting value of the roll differential component is par.

28. The index of claim 27, wherein par is 100.

29. The index of claim 27, wherein the starting value of the roll differential component is determined at least in part based on historical data for futures contracts in the basket of futures contracts.

30. The index of claim 29, wherein the historical data for futures contracts in the basket of futures contracts is used at least in part to calculated an expected negative roll amount throughout a finite term for the index.

31. A commodities futures index comprising the index of claim 19.

32. A security based on the index of claim 19.

33. A financial instrument, comprising:
a first security component that indexes to a basket of futures contracts, the basket including at least two or more sets of futures contracts with different delivery months spread over a selected time period and wherein the basket of futures contracts is rolled as certain futures contracts in the basket approach expiration;
a second security component indexes to a starting value periodically adjusted by a differential substantially equal in value to a delta between a first value of the futures contracts in the basket approaching expiration and a second value of futures contract being rolled into a forward delivery month; and
wherein a price for the financial instrument is based at least in part on values of the first security component and the second security component.

34. A financial instrument, comprising:
a rolling index component including futures contracts in a selected amount for a selected index period defined by a first month and a last month, the index being rolled by selling the futures contracts for the first month and buying an equal number of futures contracts for a new month which is after the last month.

35. The financial instrument of claim 34, wherein the index period is twelve (12) months.

36. The financial instrument of claim 34, wherein the futures contracts are for a selected commodity class.

37. The financial instrument of claim 36, wherein the commodity class is energy.

38. The financial instrument of claim 36, wherein the commodity class is agricultural.

39. The financial instrument of claim 36, wherein the commodity class includes both energy and agricultural commodity types.

40. The financial instrument of claim, 34, wherein the index is rolled on a monthly basis such that the new month is a month immediately following the last month.

41. The financial instrument of claim 34, wherein the futures contracts are selected from a group consisting of: crude oil, brent crude oil, gasoil, unleaded gasoline, jet fuel, natural gas, liquefied natural gas (LNG), propane, ethanol, heating oil, coal, and electricity.

42. The financial instrument of claim 34, further comprising a security that tracks the price of the index.

43. The financial instrument of claim 42, wherein the security is publicly traded.

44. The financial instrument of claim 34, further comprising a cumulative rolling index that tracks a price differential between the first month and the new month, whereby the price differential tracked by the cumulative rolling index offsets any price differential realized by rolling the index.

45. The financial instrument of claim 44, wherein the index and cumulative rolling index may be bought and sold as separate products.

46. A financial instrument, comprising:
a first entity holding a first structured note substantially tracking a first index component and a second structured note substantially tracking a second index component;
a second entity wherein substantially all assets of the second entity are invested in the first entity; and
wherein from the second entity a number of creation units is issued that can be purchased by one or more qualified investors.

47. The financial instrument of claim 46, wherein the first index component is an average of one or more futures contracts for a plurality of delivery expirations in which a roll is performed on a periodic basis, and wherein the second index component tracks a delta calculated using the roll.

48. The financial instrument of claim 47, wherein the first index component includes a plurality of commodity futures contracts.

49. The financial instrument of claim 47, wherein the first entity is a limited liability company.

50. The financial instrument of claim 47, wherein the second entity is a trust.

51. The financial instrument of claim 50, wherein the creation units issued from the trust each include a number of shares representing a share in the first structured note substantially tracking the first index component and the second structured note substantially tracking the second index component.

52. A system for calculating an index price for an index including a selected number of futures contracts for at least one futures type where the a selected number of futures contracts are spread among a selected time period including at least two expiration periods and wherein the selected time period is maintained by rolling the index, comprises:
a computer operative with programming to:
calculate a first index component price for the index for the selected time period by indexing values for the selected number of futures contracts for the at least one futures type included in the index;
calculate the index price by adding the first index component price to a second index component price wherein the second index component price is initially set at a first value;
recalculate the index price at least at each roll period by recalculating the first index price by indexing then current values for the selected number of futures contracts for the at least one futures type included in the index;
calculate a rolling differential value by determining a delta between a first price for the selected number of futures contracts for the at least one futures type that fall within a first period of the at least two expiration periods and a second price for the selected number of futures contracts for the at least one futures type that fall within a forward expiration month subsequent to a last expiration period of the at least two expiration periods;
adjust the first value of the second index component price using the rolling differential value; and
calculate the index price by combining the first index component price and the second index component price.

53. An index, comprising: a basket of futures contracts, the basket including at least two or more sets of futures contracts with different delivery months spread over a selected time period having a starting delivery period and an ending delivery period, wherein the basket of futures contracts is rolled as certain futures contracts in the basket approach expiration by selling the futures contracts in the starting delivery period and purchasing futures contracts in a delivery period subsequent to the ending delivery period.

54. The index of claim 53, wherein the futures contracts are commodity futures contracts.

55. The index of claim 54, wherein the commodity futures contracts are selected from a group consisting of: crude oil, brent crude oil, gasoil, unleaded gasoline, jet fuel, natural gas, liquefied natural gas (LNG), propane, ethanol, heating oil, coal, and electricity.

56. The index of claim 53, wherein the basket of futures contracts comprises a plurality of commodity futures contracts that are weighted.

57. The index of claim 56, wherein the plurality of commodity futures contracts that are weighted according at least to a production value for each of the futures contracts within the plurality of commodity futures contracts.

58. The index of claim 56, wherein the plurality of commodity futures contracts that are weighted according to a characteristic of a curve representative of a value of each of the futures contracts within the plurality of commodity futures contracts.
